(19) United States
(12) Patent Application Publication
(10) Pub. No.: US 2005/0149363 A1
(43) Pub. Date: Jul. 7, 2005

(54) Data collection and process control system

(76) Inventors: Jonathan Loiterman, Madison, WI (US); David Loiterman, LaGrange, IL (US)

Correspondence Address: SACHNOFF & WEAVER, LTD., 10 SOUTH WACKER DRIVE, CHICAGO, IL, 60606-7507, US

(21) Appl. No.: 10/752,763

(22) Filed: Jan. 7, 2004

(51) Int. Cl. G06F 17/60

(52) U.S. Cl. 705/3

(57) ABSTRACT

The present invention is a data collection system (10) including a scalable data hierarchy for process control, comprising a display screen (22), a storage device, a microprocessor, a data acquisition device (such as a client (12)), and a server (14). The display screen (22) is for displaying information. The information is stored in one or more fields, and the display screen (22) is configured to permit selection of the one or more fields. The storage device is coupled to the display screen (22). The microprocessor is coupled to the storage device and programmed with instructions for manipulating the information. The data acquisition device, such as the client (12), permits selection of at least one field from the one or more fields. Finally, the server (14) is coupled to the data acquisition device for transferring information to the data acquisition device. The server (14) is also for configuring the data acquisition device to store and collect information in the one or more fields.

### FIELD OF THE INVENTION

The present invention is directed to a data collection and process control system. More particularly, the invention relates to a portable data collection system that includes a data acquisition device or devices (such as one or more clients) and one or more servers for facilitating the synchronization of data transfer between the one or more servers and one or more databases, and for configuring the client to store and collect data or information for one or more subjects or units, wherein the data is configured according to a data hierarchy.

### BACKGROUND OF THE INVENTION

Demonstrating the hospital environment as an example, the process of providing healthcare services involves not only caregivers, but also providing those caregivers with timely and accurate information, which is both instantly accessible and capable of being securely stored. Such information assists caregivers in making the best possible decisions when confronted with choices that affect the health and well-being of patients. In a hospital or other similar environment, decision-making typically takes place on two levels: (1) on a micro or personal level and (2) on a macro or administrative level.

On a micro level, each patient has the potential to require decisions in three key areas: emergent action, daily care, and long term choices. Each of these will affect the patient's condition and determine if and how that patient will eventually return to contribute to society in a meaningful way. On a macro or administrative level, information needs to be stored and organized for research as well as regulatory and safety issues. The tracking and organization that occurs on this level is a form of process control.

Demonstrating the hospital environment as an example, the quality of the methods that are used to acquire information may be considered central to an efficiently operating hospital. Typically, a patient's physiological and other data is recorded by hand on specially organized sheets of paper. Such hardcopies are generally centrally located, making it inconvenient for people in different locations to access and view the data. Additionally, paper copies of recorded data do not easily allow for numerical or computational analysis, they generally require large amounts of physical storage space, and present opportunities for the loss of individual documents or mix up of documents between different patients.

Recently, computer innovators have constructed electronic data acquisition devices in an attempt to help overcome the limitations of paper copies. In their current state, these electronic data acquisition devices often run on a single desktop computer that multiple users must share. More particularly, the software applications running on these electronic devices are typically not robust enough to replace in their entirety the need for hardcopy documentation. For these reasons, many hospitals take hardcopy documentation, and then subsequently enter that same data into the computer.

As an example of current data acquisitions methods in a hospital setting, consider a hospital floor containing sixteen patients. Suppose the responsibility for patients is divided among four nurses and one charge nurse, for example. Typically, the nurses work the floor for an eight-hour shift. In this example, four of the nurses are each responsible for four patients, with one charge nurse managing the other four nurses.

Generally, the nurses are responsible for caring for the patients' every need. This involves feeding, administering medication, turning (to avoid bedsores), taking measurements, communication/education, tending to emergencies, and a host of other responsibilities. The nurse generally documents each of these actions using a method similar to the one described above.

The purpose of the managing, or charge nurse, is to communicate the orders from the physicians to the line nurses, who typically have less experience and training than the charge nurse. Typically, the purpose of a charge nurse is to manage the care of a large number of patients on a macro scale by ensuring that the line nurses are aware of the larger care context for each patient.

As each nurse makes rounds, the nurse performs certain tasks. Ideally, the nurse immediately records anything that was done. For example, if the nurse takes a patient's temperature, the nurse will generally record the patient's temperature and the time the temperature was measured on the patient's chart. If the nurse gives the patient medication, the nurse will generally record what the medication was, the dosage the patient received, and the time the medication was administered. If the nurse changes the patient's IV bag, the nurse will typically record the time of the bag change as well as the contents of the new bag. Often, the aforementioned information is later transferred to an electronic file either by the line nurse or other hospital personnel.

Employing a combination of both manual and electronic methods generally involves duplicating data, at the expense of timeliness and efficiency. Thus, there is needed a data collection system and method that permits an administrator or physician to determine what data sets are to be recorded and precisely when data acquisition should take place.

### SUMMARY OF THE INVENTION

The present invention is a data collection system which includes a scalable data hierarchy for process control. The collection system comprises a display screen, a storage device, a microprocessor, a data acquisition device (such as a client), and a server. The display screen is for displaying information. The information is stored in one or more fields, and the display screen is configured to permit selection of the one or more fields. The storage device is coupled to the display screen. The microprocessor is coupled to the storage device and programmed with instructions for manipulating the information. The data acquisition device, such as the client, permits selection of at least one field from the one or more fields. Finally, the server is coupled to the data acquisition device for transferring information to the data acquisition device. The server is also for configuring the data acquisition device to store and collect information in the one or more fields.

### BRIEF DESCRIPTION OF THE DRAWINGS

FIG. 1 is a block diagram of an embodiment of a data collection system formed in accordance with the teachings of this invention;

FIG. 2 shows an embodiment of a client formed in accordance with the teachings of this invention;

FIGS. 3A and 3B show the client of FIG. 2 displaying a numerical data entry module;

FIGS. 3C and 3D show the client of FIG. 2 displaying audio capturing and video-to-photo imaging modules.

FIG. 4 shows the client shown in FIG. 2 displaying a locational data entry module;

FIG. 5 shows the client shown in FIG. 2 displaying a quiz-based data entry module;

FIG. 6 shows the client shown in FIG. 2 displaying a scheduling module;

FIG. 7 shows the client shown in FIG. 2 displaying a patient selection screen;

FIG. 8 shows the client shown in FIG. 2 displaying a floor census screen;

FIG. 9 shows the client shown in FIG. 2 displaying a contextual help screen;

FIG. 10 shows the client shown in FIG. 2 displaying an application launch screen;

FIGS. 11A, 11B, and 11C show a view of statistics, groups, and templates organized using the data collection system shown in FIG. 1;

FIG. 12A shows the client shown in FIG. 2 displaying a statistic selection screen;

FIG. 12B shows the client shown in FIG. 2 displaying a view data screen.

FIG. 13 shows the flow of various statistic selection and module screens included in the client shown in FIG. 2;

FIG. 14 is a view of a patient-client matching screen that is representative of the type of assignment screen used by the server shown in FIG. 1;

FIG. 15 is a view of a typical patient configuration screen on the server shown in FIG. 1;

FIGS. 16A and 16B are diagrams shown in the typical flow through the data collection system shown in FIG. 1;

### DETAILED DESCRIPTION

The detailed description that follows may be presented in terms of programs, data structures or procedures executed on a computer or network of computers. These procedural descriptions and representations are the means used by those skilled in the art to most effectively convey the substance of their work to others skilled in the art.

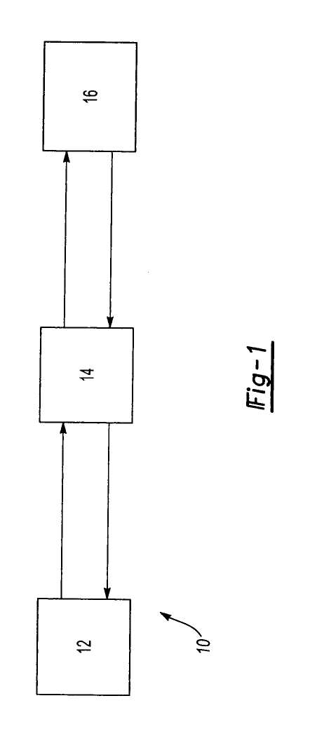

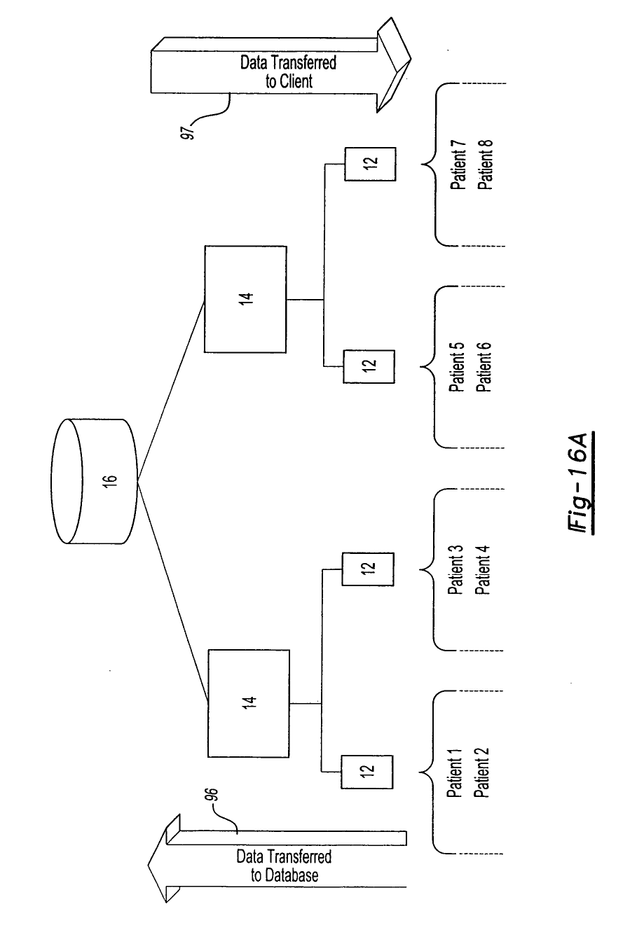

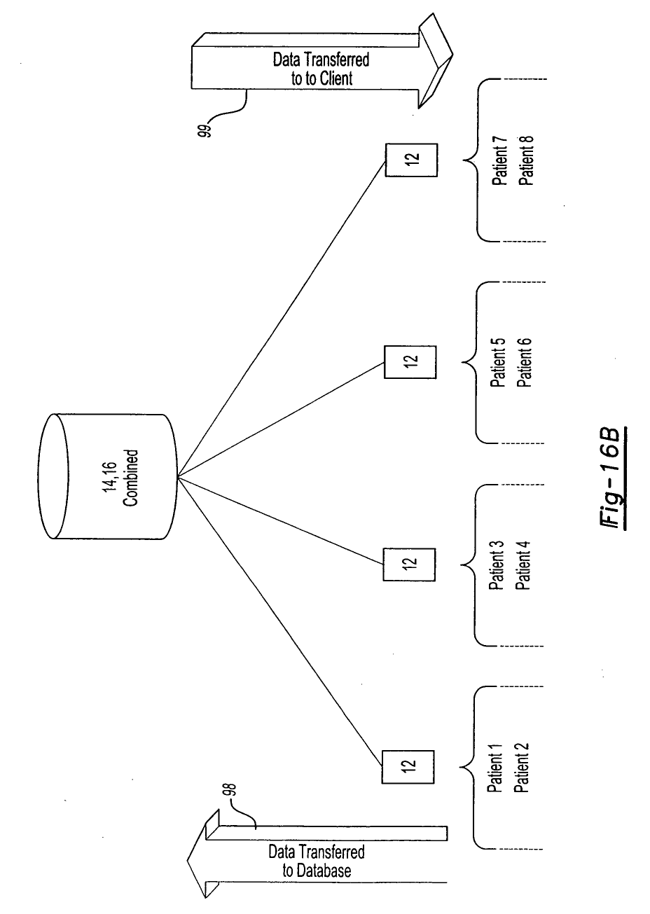

FIG. 1 shows a block diagram of a data collection system 10 formed in accordance with the teachings of this invention. As will be explained in more detail below, the data collection system 10 may be used in a hospital or other environment where data collection is required. The data collection system 10 may include a client 12, a server 14 and a database 16 as shown in FIG. 1. As best seen in FIGS. 1 and 16A, the client 12, the server 14, and the database 16 are physically or wirelessly linked so as to permit data transfer between the client 12 and the server 14 and between the server 14 and the database 16. As best seen in FIG. 16A, the flow of data transfer between the client 12 and the server 14 and between the server 14 and the database 16 is bi-directional.

Alternately, as best illustrated by FIG. 16B, the data collection system 10 may include a client 12 and a database 16. In this configuration, the function of the server 14 is coupled to the database 16. An alternative configuration further allows for the server 14 to be coupled to the client 12.

In the configurations of the data collection system 10, the data stored and collected by the data collection device 10 is preferably organized around a data hierarchy arranged in workable sets called statistics, groups and templates. A statistic is generally defined as a basic unit that represents a piece of information, action or description that cannot, for the purposes of recording its completion or status, be simplified any further. A group is generally defined as a relevant collection of statistics, and a template is generally defined as a cluster of groups. Statistics, groups and templates may be defined by using the server 14 to create objects that accept a certain data type. These objects may be organized in customized data sets that require the collection of or recordation of data or the monitoring of specific activity. In one version of the invention the objects may be selectively uploaded onto the client 12 using known techniques. In another version of the invention, the objects may be configured on the client itself.

Section I—The Data Collection System 10

For illustrative purposes only, the components to the data collection system 10 will be described herein with reference to use of the system 10 in a hospital setting. However, one of ordinary skill in the art will appreciate that the system 10 may be used in any environment where data collection, observation or recordation is required.

Client 12

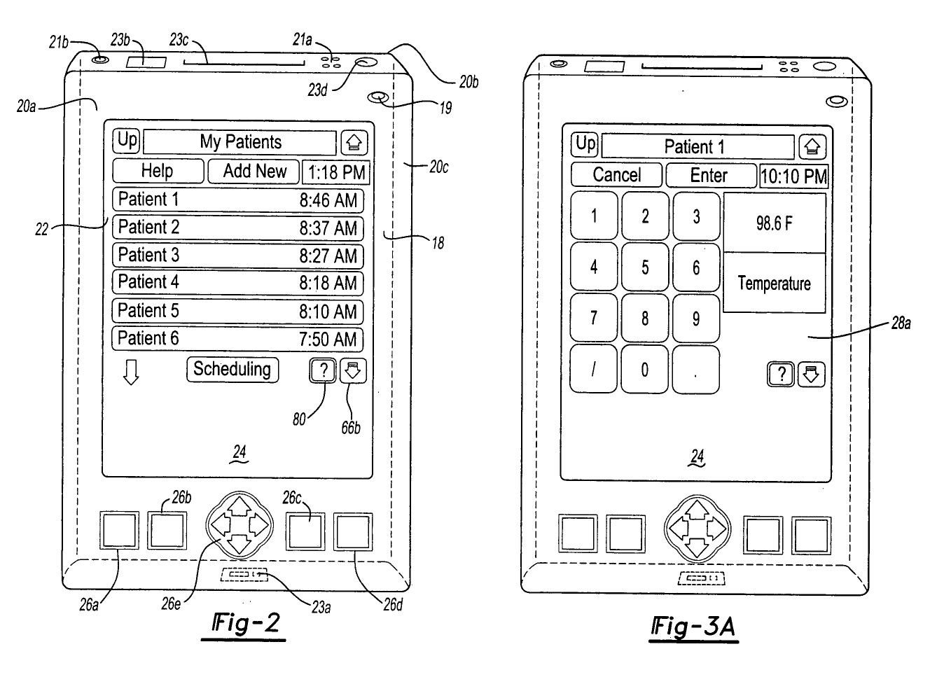

As best seen in FIG. 2, client 12 may be a data acquisition device such as a personal data assistant (PDA). PDAs such as the Compaq iPAQ™ and HP iPAQ™ series sold by Hewlett-Packard Company, the Visor® and Treo™ available from Handspring, Inc., and the Palm® Tungsten and Zire™ series, available from Palm®, Inc., or other similar devices, may be configured to perform the functions of the client 12, and may function in physically linked, wirelessly linked, peripheral, or standalone topologies, or any combination thereof.

The client 12 is preferably encased in a durable housing 18. The housing 18 defines front 20a, back 20b and sidewall 20c surfaces. As best seen in FIG. 2, the front surface 20a supports a display screen 22. Preferably, the display screen 22 is an LCD display. It will be appreciated that other displays capable of displaying alpha-numeric, graphical and international symbols could also be used. It will further be appreciated that the client 12 may be connected to one or more displays such as display screen 22.

The display screen 22 may be configured to display alpha-numeric or graphical information, or it may, for example, be configured to display physiological data in graphical form, including but not limited to, heart rate, blood pressure, temperature, and brain activity in graphical form. Additionally, the display screen 22 may be configured to display images as still images, motion pictures or other videographic images.

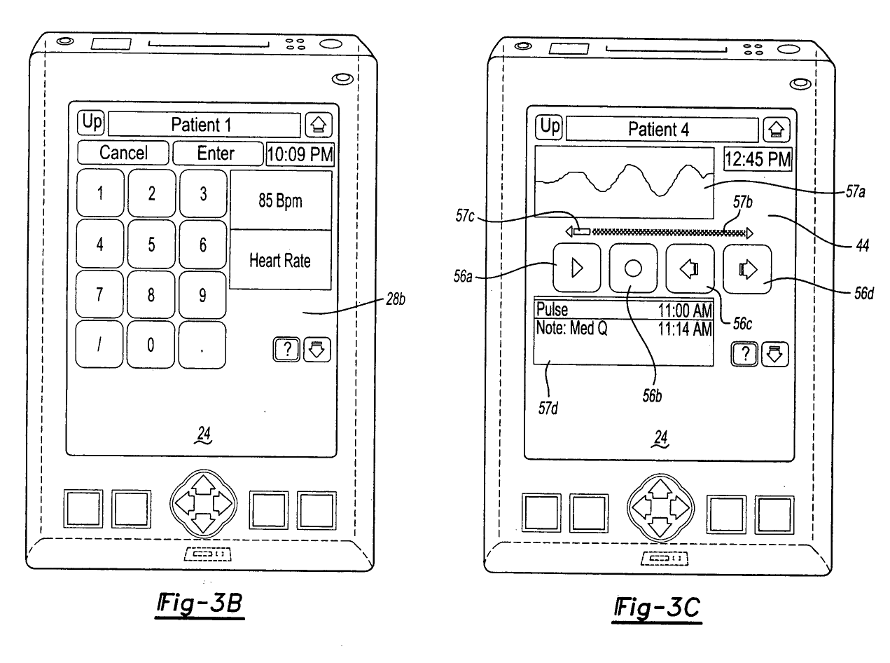

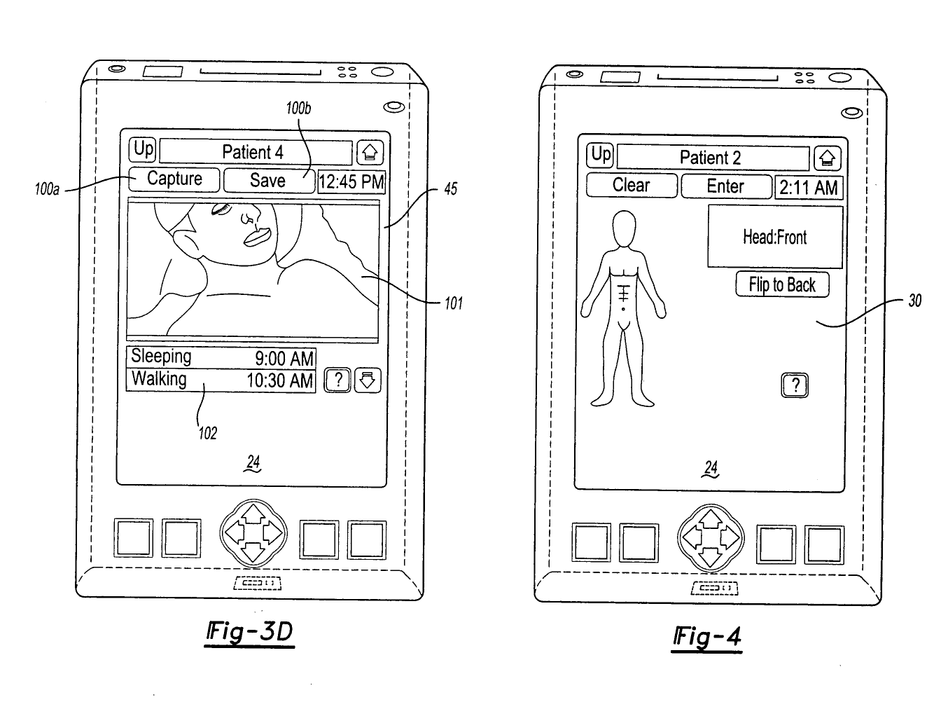

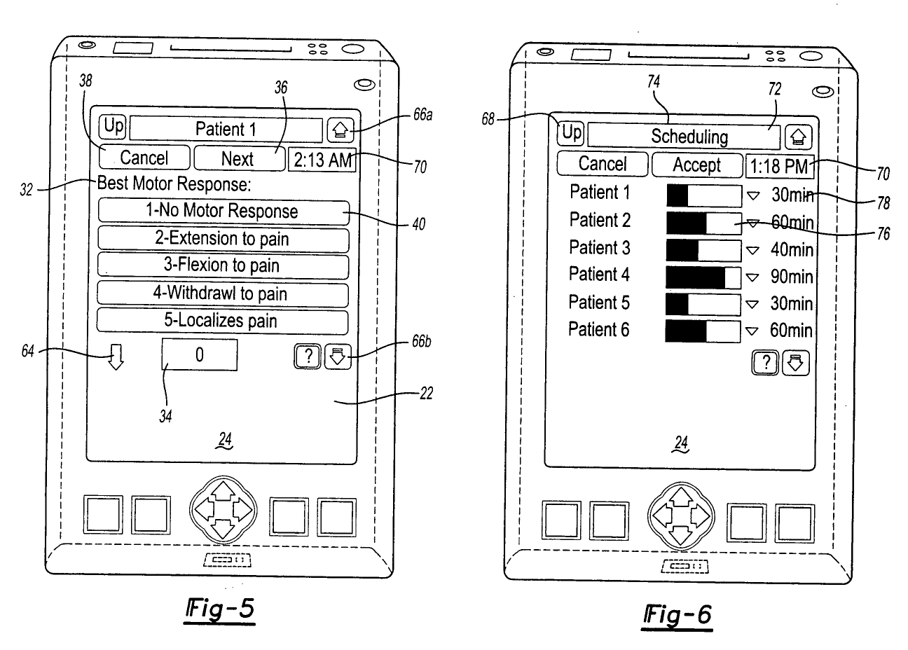

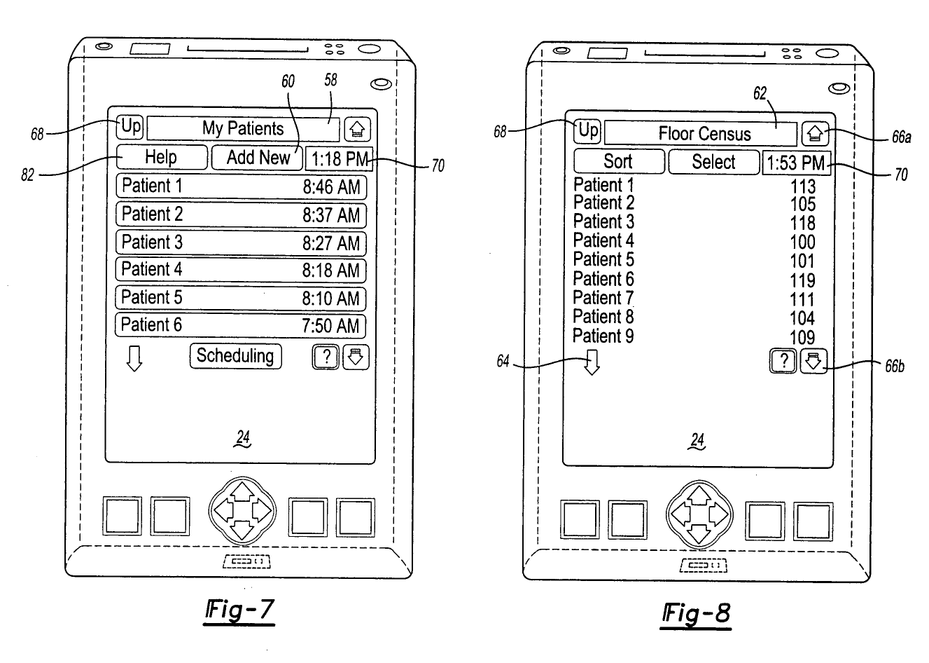

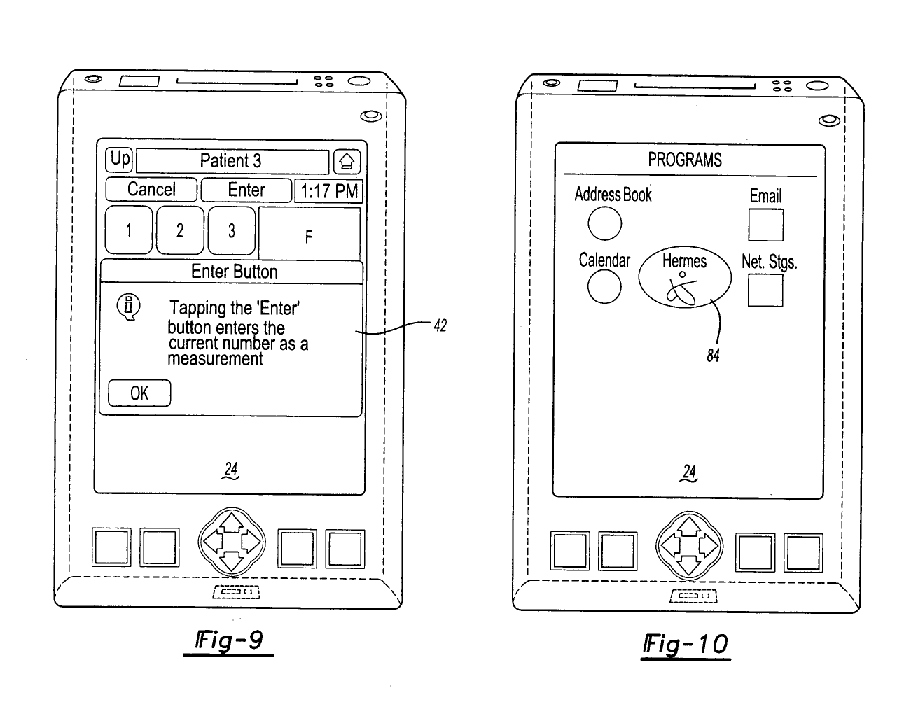

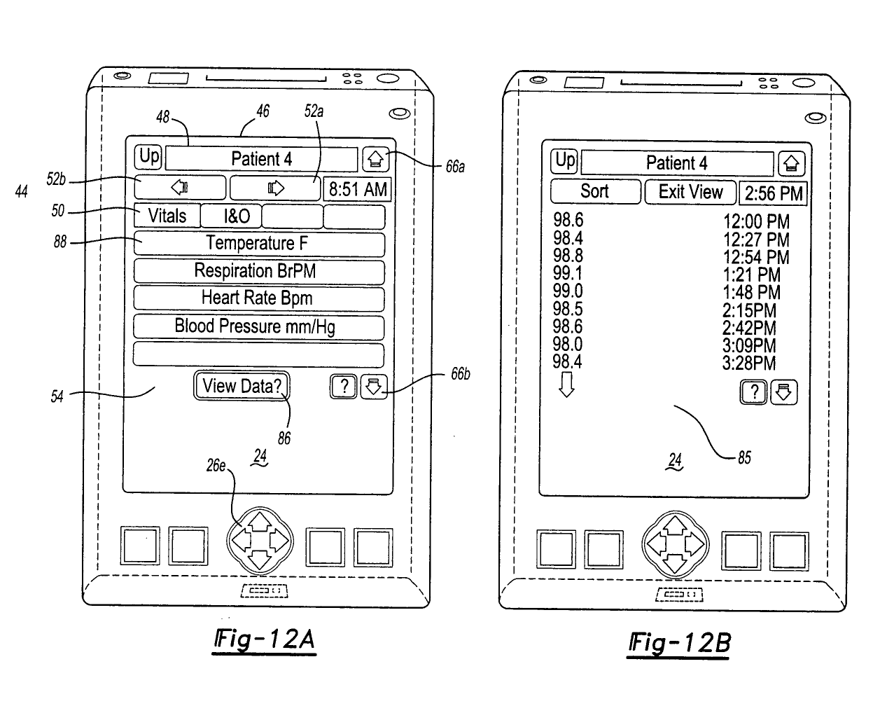

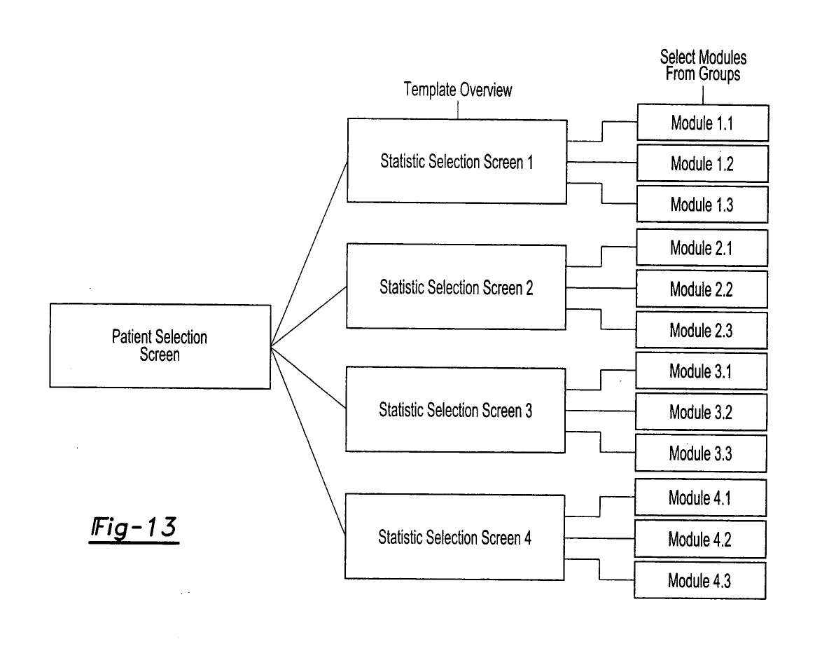

The front surface 20a also supports a power cycle button 19 and various control buttons 26a-d. The control buttons 26a-d permit a user to select various modes of using the client 12. For instance, by using the appropriate buttons the user may selectively choose among various modules or screens to be displayed on the display screen 22. The sidewall surface 20c supports various features, including an internal combination speaker-microphone 21a, combination audio input/output port 21b, serial port 23a, infra red port 23b, peripheral expansion port 23c, and stylus port 23d. The various modules or screens may include, but are not limited to, the numerical data entry module for temperature 28a and heart rate 28b (FIGS. 3A and 3B), the sound capture module 44 (FIG. 3C), the video-to-photo module 45 (FIG. 3D) which relates to a video or photographic capture peripheral attaching to and communicating with the client 12, the locational data entry module 30 (FIG. 4), the quiz-based data entry module 32 (FIG. 5), the scheduling module 74 (FIG. 6), the patient selection screen 58 (FIG. 7), the floor census screen 62 (FIG. 8), the help screen 42 (FIG. 9), the application launch screen 84 (FIG. 10), the statistic selection screen 46 (FIG. 12A), and the view data screen 85 (FIG. 12B).

The front surface 20a also supports a multi-functional, multi-directional scroller 26e, which may permit the user to page forward or backward to a desired module or screen, or navigate throughout the module options. Additionally, the front surface 20a also supports a data entry area 24. The data entry area 24 is associated with electrical circuitry that permits manual data entry by writing standard ASCII or custom symbols and characters in the data entry area 24 using a stylus or other similar device. The client 12 supports wireless communications via internal circuitry (not shown) which is internal to the housing 18. Accordingly, data may be input into the client 12 via wireless protocol or an electronic data serial port 23a (FIG. 2), wherein a keyboard, mouse, stylus, touch screen, point stick, alternative input device, voice recognition interpreter, photographic or video capture peripheral, sound capture peripheral, implanted or external bioelectric sensor, or other electronic system, including combinations thereof, may be placed in electronic communication directly or indirectly with the client's 12 internal memory. An RS232 port of a handheld PC is an example of the type of electronic data serial port 23a that may be supported by the client 12.

The client 12 also preferably includes non-volatile random-access memory (RAM). However, one of ordinary skill in the art will appreciate that other internal memory devices such as a combination RAM and read-only (ROM) memory, PROM, EPROM and EEPROM memory devices may be used. It will also be appreciated that the memory function of the client 12 may be performed by peripheral devices such as a semiconductor memory card, micro drive, hard disk, optical disk or card, fluorescent magnetic disk or card, magnetic tape, digital tape, or similar readable/writable devices or other similar devices commonly used in the computer industry. As described in more detail in Section IV, the memory device is configured to accept programming instructions and data sequences.

The client 12 also includes a microprocessor (not shown) or other circuitry for controlling and managing the memory and other electronic functions of the client 12. For instance, the microprocessor may be electrically interconnected with the memory, wherein a portion of the memory stores application programs required to permit data manipulation, display and transfer as discussed herein. The microprocessor may include circuitry and facilitate the execution of software that permits the storage, manipulation, modification and transfer of patient information, wherein the patient information may be represented in various forms.

The microprocessor permits the client 12 to be configured to implement a patient-centered data management paradigm referred to as the data hierarchy. The data hierarchy is designed around data sets or data types to be collected and will be described in more detail in Section II.

Illustrative embodiments of the client 12 have been disclosed and described. A person of ordinary skill in the art would realize, however, that certain modifications would come within the teachings of this invention. Other programmable electronic devices may be configured to perform the functions of the client 12, and may function in physically linked, wirelessly linked, peripheral, or standalone topologies, or any combination thereof. For example, other mobile computing devices such as the NEC, Inc. Mobilepro™ handheld series, the tablet, notebook, sub-notebook, ultra-light, or other similar portable computing devices, may be configured to perform the functions of the client 12. Likewise, a non-portable shuttle, desktop, thin client, tower, server, or other similar computing device may be configured to perform the functions of the client 12. Moreover, a wireless data device, storage or photo device, mobile pager, telephone, MP3 player, camera, electronic organizer, or other similar devices, and any multifunctional devices which combine such or other similar devices, may also be configured to perform the functions of the client 12. Therefore, the following claims should be studied to determine the true scope and content of the invention.

Server 14

The server 14 may be a computer or other device used to upload/download information to the database 16 or the client 12. More specifically, the server 14 is typically used to configure the client 12 to acquire the appropriate set of data at the appropriate times. The server 14 may link with the client 12 in many different ways not limited to the Input and Output (I/O) interfaces discussion in Section IV.

Further, it will be appreciated that server 14 may use any wireless protocol to transfer information to not only database 16 but also the client 12. An example of a wireless specification that could facilitate wireless operation as described would be 802.11g, wherein not only database 16 but also the client 12 would support and communicate with hardware that allowed a connection to an 802.11g or similar wireless networking protocol. Also possible are other wireless specifications, such as 802.11a or 802.11b, or a multi-band combination of specifications, but the wireless protocol need not be limited to the foregoing, or to those of the Institute of Electrical and Electronic Engineers (IEEE). Other more advanced long range, medium range, or short range wireless protocols may also be used. Using common short to medium range wireless protocols, data may be input into the client 12 using the Bluetooth™ other similar RF protocols, the IR, Fast IR or other similar protocols, or the 900 MHZ, 2.4 GHZ, or 5 GHZ digital spread spectrum (DSS) or other similar protocols, which may or may not use digital signal processors (DSP).

It will be appreciated that server 14 may be alternatively or simultaneously linked to client 12 and database 16 using a full range of available data linking protocols known in the industry.

Database 16

The database 16 generally may be an electronic filing system, wherein information added, removed, viewed or modified by a computer program or other similar device is organized and stored. It will be appreciated that the database 16 may be configured to store data in one more fields as records and/or files. As known to one of skill in the art, a field generally represents a piece of information; a record generally represents one or more fields; and a file is typically considered one or more records.

To access the information stored in the database 16, commonly known and used database management system software is used to affect communication between the database and the server 14.

For illustrative purposes the database 16 described herein is a type that may be used in a hospital setting. However, one of skill in the art will appreciate that the database 16 may be configured for use in an unlimited number of environments.

As illustrated in the example described herein, the database 16 may communicate with the server 14 to permit bi-directional flow of information, as illustrated in FIG. 16A. Alternatively, it will be appreciated that the database 16 may be configured to include the server 14 or may be stored as part of the client 12.

Section II—Data Hierachy

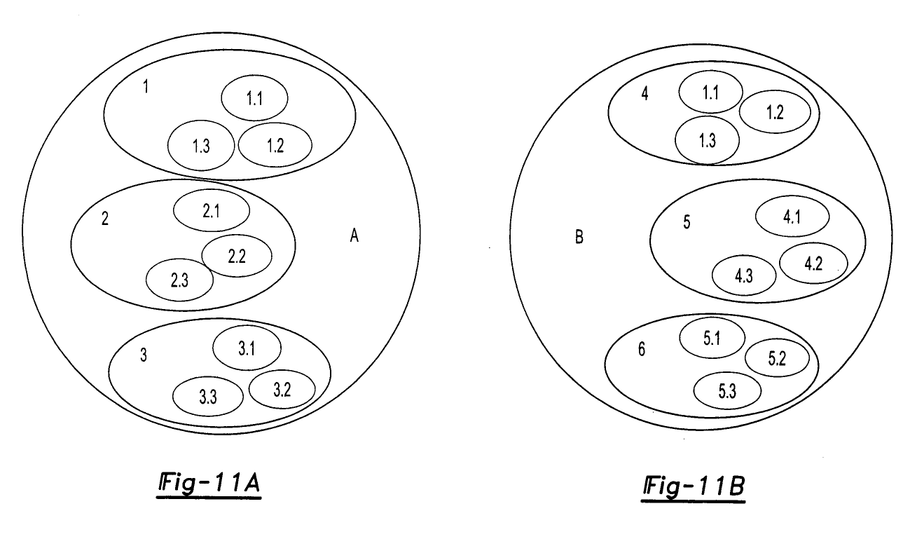

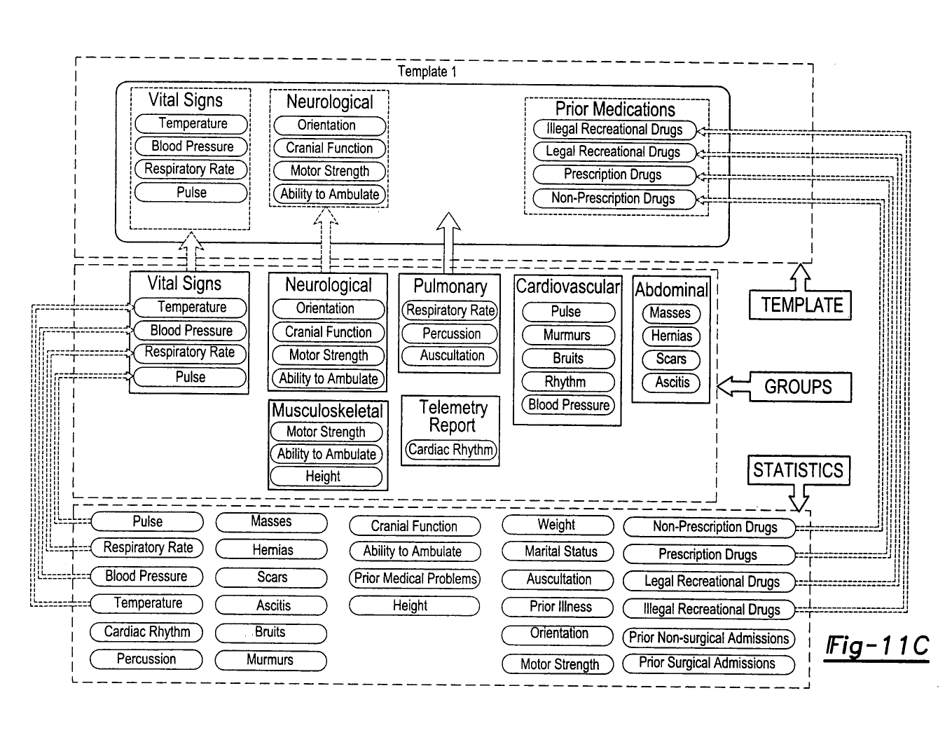

The data collection system 10 supports underlying data architecture referred to herein as the data hierarchy, which includes statistics, groups and templates, as best illustrated in FIGS. 11A-C. More particularly, the client 12 may be configured to implement the data hierarchy by uploading or downloading information to or from the client 12 via the server 14. It is the data hierarchy that binds the client 12, server 14 and database 16 together with a consistent model that communicates data types and acquisition methods. The data hierarchy also permits communication and cooperation among the client 12, server 14 and database 16.

FIG. 11C illustrates a template in the making comprised of statistics and groups. Each element of the data hierarchy is described in more detail below.

Statistics

A statistic is a basic unit that represents a piece of information, action or description that cannot, for the purposes of recording its completion or status, be simplified any further. For example, Tables 1 and 2 list examples of statistics that may be applicable for use in the data collection system 10 in a hospital setting. Such statistics may include, for example, temperature, blood pressure, respiration, pulse, urine I&O, blood I&O. Thus, a statistic represents the actual measurements or action items that a user of the client 12 must supervise, obtain, monitor, or observe.

A statistic may also be a single photographic image or a discrete segment of video or sound. Some of the actions required of a user for a single statistic may be simply to record numerical values or text for the statistic displayed. Other actions may require moving or communicating with the patient. Still other actions may require other interaction with the patient to obtain information relevant to the statistic under consideration.

Statistics have properties that are used to define how a statistic is used. For example, a statistic may have a frequency property that is used to define how often that statistic should be acquired or a security property that defines which type of personnel are permitted to enter data for that statistic.

The data hierarchy permits the organization of statistics in at least two ways. First, the statistics may be organized into clinically related clusters as best illustrated by Tables 1-20. However presented, organized, or utilized, a statistic need not be measured more than one time unless there is reason to do so.

As best illustrated by Tables 1-20, statistics are defined from a pool of data types. However, the data types shown in Tables 1-20 may not be sufficient to describe the precise set of data types needed to be monitored or measured for a particular patient. Thus, one of skill in the art would appreciate that the data types selected to define statistics may vary depending on the type of information to be monitored, observed or measured. Tables 1-20 show examples of data types that may be used to define statistics. It will be appreciated that a virtually unlimited number of data types may be created.

In addition to the data types shown in Tables 1-20, the data hierarchy may include data types that define statistics concerning patient background information such as past medical history or personal information, e.g., name, address, telephone number, etc., education, communication skills, language, telemetry reports, photographic, video, audio, and other similar information.

Groups

To make statistics more useable, statistics may be arranged into more general clusters called groups. For purpose of use in a hospital setting, the term “group” may refer to a clinically relevant collection of statistics. That is, the statistics are combined to form a particular group having clinical relevance in a particular application of clinical practice. For example, the statistics presented in Tables 1-20 are arranged into physiologically or methodologically related clusters that may be referred to as a group. In most instances, not all the statistics forming a particular cluster are desired or needed in caring for any one patient. It is more likely that the patient's diagnosis will result in the application of some, not all, of the statistics defining a particular group.

Additionally, groups may be created by combining statistics from different physiological or methodological clusters. One such group could be called “Patient Discharge”, including any number of statistics such as: information about when the patient should return to his or her doctor for a follow up; distribution of educational material regarding surgical recovery; and, any other actions or activities that should be executed at the end of a patient's stay at the hospital. In the “Patient Discharge” group example, the statistics “information about when the patient should return to his or her doctor for a follow up” and “urine” derive from different clusters. Thus, groups may contain any number or a variety of statistics. In practice, groups may be used to encapsulate a specific aspect of a patient's care.

It is also possible to create several groups composed of the statistics shown in the clinical cluster of Table 2. One such group could include the urine and stool statistics. Another group could contain the urine and stool statistics as well as the IV statistic.

| TABLE 1 | TABLE 2 | TABLE 3 |
|---|---|---|
| Vital Signs | Intake and Output (I&O) | Activity Levels |
| Temperature | Urine | Walking |
| Blood Pressure | Blood | Sitting |
| Respiration | Tube Feeding | Standing |
| Pulse | PO Fluids | Running |
| | IV | |
| | Catheter | |
| | Stool | |
| | Nasal-Gastric Tube | |
| | Drains | |

| TABLE 4 | TABLE 5 | TABLE 6 |
|---|---|---|
| Elimination | Telemetry Report | Wound Assessment |
| Urine | Cardiac Rhythm | Decubitus |
| Stool | | Characteristic |
| | | Location |
| | | Stage |
| | | Drainage |
| | | Rash |
| | | Contusion |
| | | Laceration |
| | | Casts |

| TABLE 7 | TABLE 8 | TABLE 9 |
|---|---|---|
| Equipment | Hygiene | Laboratory Instructions |
| Traction | Bath/Shower | Serum Chemistries |
| Bed and Mattress | Assistance Level | Urine Chemistries |
| Stockings | Oral | Blood Gases |
| Monitors | Assistance Level | Cultures |
| Infusion Devices | Skin Care | |
| Intermittent | | |
| Compression Pump | | |

| TABLE 10 | TABLE 11 | TABLE 12 |
|---|---|---|
| Imaging Instructions | Pain | Nutrition |
| X-ray | Scale/Magnitude | Type |
| Ultrasound | Site | Supplements |
| MRI | Character | Appetite Level |
| CAT (PET) | | Assistance Level |
| | | Tube Feeding |
| | | Food Intake |
| | | Liquid Intake |

| TABLE 13 | TABLE 14 | TABLE 15 |
|---|---|---|
| Nasal-Gastric Tube | Respiratory | Glucose |
| Suction Device | Oxygen Delivery | Serum Level |
| | Method | |
| Drainage | Flow Rate | Method |
| Placement | Ventilator | Scale/Coverage |
| Irrigation | Tracheotomy Care | Urine Level |
| | Cough Character | |
| | Secretions | |
| | Chest Tube | |
| | Deep Breath | |
| | Incentive Spirometry | |

| TABLE 16 | TABLE 17 | TABLE 18 |
|---|---|---|
| Neuro Assessment | Cardio/Pulmonary | Gastro-Intestinal |
| Level of | Skin Character | Abdomen Character |
| Consciousness | | |
| Orientation | Turgor | Bowel Sound |
| | | Location |
| Behavior | Color | Bowel Sound |
| | | Character |
| Pupil Response to | Breathing | Flatus |
| Light | | |
| Tongue | Pulse Character | |
| Hand | Edema | |
| Speech Character | | |
| Movement | | |

| TABLE 19 | TABLE 20 |
|---|---|
| Dressing | Education and |
| Drainage | Communication |
| Incisions | Exercise |
| Dressings | Diet |
| Drainage Device | Family Counseling |
| Drainage Character | Diabetes Education |
| | Discharge |
| | Instructions |

Templates

Groups may be organized into related clusters referred to as templates. Templates are essentially clusters of groups. For illustrative purposes of use of the data collection system 10 in a hospital setting, the term “template” shall refer to a cluster of groups arranged according to a particular diagnosis. A template is meant to encapsulate the acquisition content for a specific diagnosis by containing only those groups that specifically apply to that diagnosis. More than one template may be applied to any particular patient, as a single patient may be subject to multiple diagnoses. Thus, a template is intended to encapsulate virtually all of the groups and statistics that relate to one or more diagnoses.

For example, suppose a given patient has been hospitalized due to numerous minor injuries. A template identified as MINOR1 could be used to monitor the patient's medical condition. MINOR1 may contain the group VITAL1, which may contain only the temperature statistic. Additionally, template MINOR1 may also include the group WOUND1, which contains statistics for the location, severity, and status of the wounds.

Templates may also be applied to a patient according to a set of undiagnosed symptoms. Using one or more symptomatic templates, the endpoint is the discovery of a diagnosis and not discharge from the hospital, as is the case with a diagnostic template. Thus, in applying templates to a patient, the user may employ not only diagnostic templates but also symptomatic templates.

Templates may be preconfigured based on common or frequent diagnoses. For example, emergency room treatment records may provide a basis for preconfiguring templates. Thus, communicating the specific acquisition content for a particular patient based on a particular diagnosis or diagnoses may be as simple as selecting the appropriate preconfigured template or templates.

FIGS. 11A and 11B show groups and statistics, represented by the numerical values, arranged into templates identified as A and B. The whole numbers, one through six, represent groups, and the decimal numbers located inside the groups represent the statistics. Thus, applying template A of FIG. 11A to a patient results in the application of all the appropriate statistics.

Templates and groups are customizable, so that different practitioners from the same or varying disciplines may utilize the same statistic to build one or more groups for one or more templates. For example, if a nurse anesthetist needs to track urine output on every patient, the system may be modified to accommodate the request. Similarly, if a general surgeon also decides to track urine output, the request may be accommodated.

Furthermore, both requests for using the urine output statistic may be accomplished in a variety of ways. For example, a special template or group containing the required statistics may be created, or the user may simply add the desired statistic to the data set to be measured or monitored. FIG. 11C shows an example of a customized template in the making, where, for example, a physician has specified exactly what statistics and groups are to comprise the template and exactly when the data is to be recorded. Thus, from the non-exhaustive sample of statistics shown in FIG. 11C, the groups “Vital Signs, “Neurological”, “Pulmonary”, and “Prior Medications” were created, in order to form a customized clinical template, used to collect precise data sets at precise time periods. It will be appreciated that one or more customized templates may be created, whether from pre-existing groups, newly defined groups, or a dynamically growing pool of statistics.

As illustrated by the above discussion, the data hierarchy may implement a patient-centered data management process. Alternatively, the data hierarchy may be further defined to include meta-statistics implemented by meta-modules (both of which will be discussed below).

Section III—Implementaton of the Data Hierhacy Modules and Screens

It will be appreciated that different data types may need to be entered in different ways. For example, numerical data may need to be entered differently than descriptive data; descriptive data may be entered differently than checklist type data, and checklist type data may be entered differently than locational data. Photographic, video, or sound type data would also require a specialized interface. In contrast to screens, which are used to view data, the data collection system 10 may include a set of modules designed to permit entry of various data types.

Modules

As used herein the term “module” refers to a customized user-interface that is designed to record specified data types. The number of modules that may be used with the data collection system 10 are unlimited. To be included in the data collection system 10, a new module merely needs to be compatible with or rendered compatible with the client 12 hardware and software, and should be capable of implementing one or more statistics. For instance, modules run on the client 12 must permit recordation or monitoring of one or more statistics.

Thus, in a preferred embodiment, a statistic needs a module designed to accommodate that statistic's data entry requirements. For example, (1) statistics that require the recordation of numerical data preferably require a numerical data entry module such as 28a or 28b including a number pad similar to that used for calculators or telephones; (2) descriptive statistics e.g., speech character or response to dietary changes, preferably require the use of a descriptive data entry module, which preferably might simply include a space for entering text; (3) locational statistics require the use of a locational data entry module 30 that preferably includes an image representative of the human body onto which specific bodily locations may be referenced; and (4) in addition to the possible use of an extended microphone, video, or photographic peripheral interfacing with combination audio input/output port 21b or expansion port 23C, capturing image and sound statistics preferably requires the use of the sound capture module 44 and video-to-photo module 45. These modules preferably include a preview tool to facilitate the viewing of images, video, or sound before they are committed to storage. One of ordinary skill in the art will appreciate that a module may be designed to accommodate one or more statistics.

FIGS. 3A and 3B are screenshots of two representative modules. Both FIGS. 3A and 3B show a handheld device implementing a temperature numerical data entry module 28a and heart rate numerical data entry module 28b in the event the statistics to be measured, temperature and heart rate, require the manual entry of numerical data. For example, the two dimensional array of numbered buttons and symbols shown in FIGS. 3A and 3B are used to enter the actual number. The box at the upper right of the screen is used to display the number as the user enters it as well as the unit for the current measurement. The box immediately below is used to remind the user of what statistic the user is currently entering. At the top, the title bar, as mentioned earlier, displays the name of the current patient, to avoid entering information for the wrong patient. The “Enter” button is used to confirm the entry, while the “Cancel” button is used to clear the current numerical entry, as displayed in the upper right box.

FIGS. 3C and 3D show an example of a media capturing module. The acquisition device of FIG. 3C shows the sound capturing module 44 which may be used to capture any number of sounds, such as heart beat, pulse, speech, or dictation. Sounds may be captured using the internal combination speaker-microphone 21a. Alternatively, for a more sensitive reading, an extension microphone may be configured for use, either by wired connection to the combination audio input/output port 21b or wirelessly using the Bluetooth™ or other wireless protocol. The user initiates a recording to capture a sound statistic by using a familiar recording interface similar to that of a CD player. As shown in FIG. 3C, the sound capturing module 44 console is comprised of virtual buttons for play 56a, record 56b, rewind 56c, and forward 56d.

To start or stop a sound capture, the user taps the record 56b button. The user monitors the recording volume as it registers in real time by viewing the graphical audio register 57a. The user may gage the sound clip position relative to the beginning and end of the recording time by viewing the position of the moving clip 57c on the play progress bar 57b. Upon stopping and optionally previewing a recording, the user is prompted to enter a title for the captured sound statistic via the data entry area 24 and a time stamp is automatically added. The recordings list may be viewed and selected for playback in the record file menu 57d.

FIG. 3D shows an example of a video-to-photo module 45 for capturing either video or photo images via a peripheral device which may be attached via expansion port 23c. As shown in FIG. 3D, by employing the video-to-photo module 45, any photographic or video statistic may be acquired, such as the statistic of an object's color, or the statistic of a subject's walking or sleeping. A combination video and photographic capturing peripheral which connects to expansion port 23c is preferred. Alternatively, the user may attach and employ a video capturing peripheral to take a photograph. As discussed below, the user may capture a video and then pause the digital video image to extract a desired still frame and save it as a photograph. One of skill in the art will appreciate that the expansion port 23c is a multipurpose expansion slot which can accommodate any type of compatible peripheral, not limited to photographic and video peripherals.

To capture a photographic image with a corresponding photographic peripheral attached to expansion port 23c, the user taps the capture button 100a and the picture is taken and immediately previewed in the view image screen 101. To save the previewed image, the user taps the save button 100b and gives the image a title via the data entry area 24. Consequently, the image title and auto time stamp appear in the captured file menu 102.

To capture a video with a corresponding video peripheral attached to expansion port 23c, the user taps the capture button 100a which initiates video recording. Tapping the capture button 100a for a video also invokes a hidden control panel identical to that shown in FIG. 3C with buttons 56a-d, the play progress bar 57b, and the moving clip 57c which moves along the play progress bar 57b. Video recording continues until the user taps the 100a capture button a second time, thus stopping the recording and consequently prompting the user with the option to preview or save the video recording.

The user may play and stop playing the saved video using the control panel button by pressing and depressing the play 56a button. Similarly, the user may rewind and stop rewinding or fast forward and stop fast forwarding by pressing and depressing the rewind 56c or forward 56d buttons respectively. The user may utilize the moving clip 57c of the play progress bar 57b to jump to a time frame in the captured video.

The user may capture a video and then pause the digital video image to extract a desired still frame and save it as a photograph. By tapping the record 56b button on the control panel while the video is playing back, the user may extract and save a still image photograph from the video. Upon tapping the record 56b button, the instant image is saved as a photograph and the user is prompted to give the saved image a title and the auto stamp attaches to the title as shown in the captured file menu 102.

FIGS. 4 and 5 show two other prototypical modules. FIG. 4 is representative of a locational data entry module 30, and FIG. 5 is representative of a quiz-based data entry module 32. The module shown in FIG. 4 is used to mark locations on the screen image of a human body. Tapping on any portion of the on-screen body image will cause the name of that part to be displayed in the box at the right. Tapping on another part will clear the first name in the box and display the newly indicated body part. If the user would like to enter a part on the back of the body, tapping the “Flip to Back” button will rotate the body diagram to an image of the back of the body. Once again, tapping on any body part shown on the on-screen image causes that part to be displayed in the upper right box.

Once flipped to the back, the “Flip to Back” button becomes the “Flip to Front” button, which, quite obviously, flips the diagram to the front of the body. The “Enter” button is used to confirm the entry, while the “Clear” button clears the box at the upper right. This kind of user-interface may be used to note the location of IV sites, bedsores, cuts, bruises, etc. If needed, this module could also be configured to support zooming in or out on selected portions of the on-screen image.

The quiz-based module shown in FIG. 5 permits a user to use a custom or preconfigured series of questions. Preferably the questions will have a pre-defined set of possible responses to quickly determine the patient's status or the relevant statistics associated with the patient's diagnosis. For example, FIG. 5 shows a list of possible responses for the first question in a Glascow Coma Scale Test. The score box 34 at the bottom of the display screen 22 displays the current score of the quiz. The “Next” button 36 allows the user to skip to the next question without logging a response. The “Cancel” button 38 exits the quiz or returns to the previous question, depending on context.

The vertically aligned buttons 40 in the center of the screen list the possible responses to the query listed above the set of proposed responses. The up arrow 66a at the top and the down arrow 66b at the bottom right of the screen are used to access these additional options. Tapping on any of the responses adds the numerical value of that response to the box at the bottom of the screen and takes the user to the next question in the quiz. Once the user reaches the final question in the quiz, the user taps the “Next” button 36 which, in the case of the final question, will change to “Enter”.

Modules may also be designed to include a “lock” feature. This simply means that the modules associated with a particular client 12 would be unchangeable and un-editable by users or developers. Preferably, however, any number and type of modules may be implemented by a client 12. Module types may be added as necessary to accommodate recordation, monitoring or other manipulation or screening of a particular statistic. In an alternative embodiment, individual modules could be added to the client and associated with statistics without requiring a modification of the entire system.

Aside from the modules specifically discussed here, there are a number of other modules that will be useful for use with the client 12. One such module is a photographic module. The photographic module accepts digital photographs as a data type. Hence, the client 12 would need to be configured to include a photograph statistic.

Another useful module is a dedicated medication module. The dedicated medication module would typically be used in conjunction with a group of medication statistics. The dedicated medication module would typically be used to remind or prompt users when to medicate each assigned patient with what medications and the dosage.

Meta-Statistics

Meta-statistics are clusters of statistics. While groups are also clusters of statistics, meta-statistics are different from groups in two ways. First, meta-statistics have properties that are used to define how a statistic is used. For example, a statistic can have a frequency property that is used to define how often that statistic should be acquired or a security property that defines which type of personnel are permitted to enter data for that statistic. Meta-statistic properties can further incorporate a granularity of detail property that uses pre-defined levels to determine which among a set of statistics will be included. For example, any given patient may be given a basic neurological examination consisting of their ability to talk, walk, and see, whereas a head trauma patient may require a more detailed examination including everything from the basic neurological examination as well as assessments of all the cranial function and a detailed evaluation of cognitive function. A granularity property would define two or more statistics to activate for the meta-statistic. If the granularity should be raised or lowered, the set of activated statistics would respond accordingly.

Second, while groups are implemented using modules, meta-statistics are implemented using meta-modules, which are described below. This is because meta-statistics do not demand actual data entry; they serve, essentially, as gateways to standard statistics.

Meta-Modules

Meta-modules implement meta-statistics. Like standard modules, which are used to acquire data for statistics, the meta-module is dynamic. One use of meta-modules could be to group a number of true/false questions which, as statistics, would normally be collected separately using multiple iterations of a true/false module for each statistic. Such statistics may be clustered into a single meta-statistic that may be implemented by a single integrated meta-module. For example, the interface may consist of a series of checkboxes to allow the user to enter true/false or binary data for several statistics all at once.

Meta-module features include the ability to change the granularity property of meta-statistics, and the ability to tie together interfaces, for example, to collect video or sound with alphanumeric data.

Furthermore, meta-modules are built at the server 14 level using a constructor tool. The function of the constructor tool is two-fold. First, the constructor tool allows users to arrange user-interface objects like buttons, checkboxes, text fields, slider bars, pull down menus, toggle switches, etc. onto a blank space. Second, the user is permitted to connect the operation of these user-interface components to the data portion of the statistic being measured or observed, one or more of the statistic's properties, and the module itself via a button that calls up the original module.

Some meta-modules may also be included as a standard part of Hermes, while additional meta-modules may be developed by third parties.

Screens

Typically, one begins use of the client 12 by accessing the statistic selection screen 46. The statistic selection screen 46 is automatically customized for each patient by the client 12 based on information input into the client 12 by the server 14. The process for configuring the client 12 is discussed in Section IV below.

As best seen in FIG. 12A, the statistic selection screen 46 includes a title bar 48, which displays the particular patient's name. In this case, the hypothetical patient is Patient 4. The statistic selection screen 46 also displays one or more group tabs 50. Due to limited screen space, there are only four group tabs 50 shown; however any number of tabs may be used. For example, if Patient 4's template implicates more than four groups, the user may scroll to see the others by using the right/left arrow buttons 52a-b just above the group tabs 50 or the multi-directional scroller 26e. It will be appreciated that such operations, or any operations that involve giving input to the client may be performed with peripheral devices, and that the statistic selection screen 46 may be customized to include different group tabs.

The manipulation of the group tabs 50 permit the display of the list of groups, e.g., Vitals and IV, and associated statistics, e.g., temperature, respiration BrPM, heart rate Bpm and blood pressure, mm/hg, to be measured or monitored for Patient 4. If a patient has more than one template that implicates any group, the client 12 will recognize that group as having been entered once. Additionally, if more than one of a patient's groups implicates the same statistic, the statistic will appear in the module listing for both groups. However, both modules will ultimately record data in the same place.

When considered as a whole, the group tabs 50 define the template or templates to be run for Patient 4. Tapping on a group tab 50 causes that group's associated statistics to be listed in the statistic/module display area 54. Once again, due to limited screen space, there are only five statistic/module buttons 88 shown. However, if there are more than five statistics associated with any group, the user may use the up/down arrows, 66a and 66b, to scroll through the list on the patient display screen. Meta-statistics and meta modules are accessed and organized in substantially the same manner that statistics and modules are accessed and organized. That is, meta-statistics are listed on the statistic/module buttons 88 on the statistic selection screen 46 just as standard statistics would be. Similarly, meta-statistics and meta-modules are assigned to groups in substantially the same way that standard statistics are assigned.

Tapping on any statistic/module button 88 takes the user to a module interface for the associated statistic. Preferably, the user may only enter specific modules from the statistic selection screen 46. Since the modules are preferably configured to be patient specific, any information entered through a module will be stored as data associated with a specific patient.

As discussed hereafter under the Application Launch section, the user may toggle the functionality of the statistic module buttons 88 by engaging the view data button 86. Selecting the statistic module buttons after engaging the view data button 86 allows the user to view the stored data which he or she has input.

Even though the client 12 is designed around the data hierarchy, the flow for the user is preferably centered on the patient. As best seen in FIGS. 7 and 13, there is a patient selection screen 58 that permits the user to select the specific patient of interest. Selecting a patient brings the user to that patient's customized statistic selection screen 46, as illustrated by example in FIG. 12A. FIG. 13 demonstrates how the user may be guided through the components of the data hierarchy by descending through the patient profile for which the client 12 has been configured.

Referring now to FIG. 7 for a more complete discussion of the patient selection screen 58, the patient selection screen 58 is typically the first screen a user will see upon activating the client 12. As best seen in FIG. 7, the top portion of the patient selection screen 58 is labeled “My Patients.” Thus, this screen 58 lists the patients assigned to the user of the particular client 12. Due to limited screen space, there are only six slots shown in the My Patients list. However, there may be any number of patients in the user's My Patients list.

The button 60 near the top of the patient selection screen 58 labeled “Add New” is used to add additional patients to the My Patients list from the pool of current or admitted patients. Such actions could be regulated by security measures. Additionally, a user may acquire or monitor data for new patients selected from the pool of patients by using the floor census screen 62 as best shown in FIG. 8.

To survey the complete list of patients on the floor census screen 62, the user looks for the view more indicator 64 on the bottom left of the screen, as best seen in FIG. 8. The view more indicator 64 indicates that there are more patients below the currently viewable My Patients list. In the event that there are more patients above the currently viewable list, the view more indicator 64 will point up. If there are more patients in both directions, the view more indicator 64 will point in both directions. To survey the complete list of patients on the floor census screen 62, the user employs the up/down arrow buttons 66a at the top and 66b at the bottom right of the screen to scroll through the My Patients list. The contents of the floor census list are obtained from the server 14 through the configuration method discussed in Section IV.

The vertically aligned hardware buttons 26a-d located on the client housing 18 also permit scrolling through the My Patient List list. However, these buttons 26 include the capability of permitting scrolling in full screens. For example, if there were twelve patients, manipulating either the up/down buttons 26 permits alternating between each group of six.

As best seen in FIG. 7, and as shown also in FIGS. 6 and 8, there is at the top left of the patient selection screen 58 a button 68 labeled “UP”. This button 68 is used to ascend through the user-interface hierarchy. Visually, this corresponds to traversing the user-interface flow chart shown in FIG. 13 from the right towards the left. In general, selecting or activating items traverses the user-interface flow chart towards the right.

Using the UP button 68 from the statistic selection screen 46 takes the user to the patient selection screen 58. Using the UP button 68 from a module takes the user back to the statistic selection screen 46. Using the UP button 68 from the statistic selection screen 46 exits the program. Essentially the UP button 68 ensures that users always have the ability to “go back.” Preferably, the UP button 68 is available on every screen used by the client 12.

As best seen in FIGS. 6-8, the patient selection screen 58 displays a clock 70. The clock 70 preferably operates in real-time and always displays the actual time based on the client's 12 internal system clock. The client 12 may be configured such that the clock 70 appears on every screen displayed by the client 12.

In a preferred embodiment, the displayed time is automatically entered and recorded whenever a module entry is made. Thus, the actual time that the user recorded the statistic is saved, and preferably, measurement and recordation occur nearly simultaneously.

As best seen in FIG. 6, the button 72 labeled “Scheduling” is a link to a special module identified as the scheduling module 74. The scheduling module 74 is different from other modules in that, it does not apply to a specific patient. Instead, the scheduling module 74 applies to all patients.

FIG. 6 shows a user-interface for the scheduling module 74. The progress bars 76 to the right of each patient's name indicate visually how much time is remaining until the patient's next scheduled checkup. The entire progress bar 76 represents a total time of two hours. The labels 78 to the right of each progress bar 76 indicate how much time is remaining before the next patient checkup is due. The scheduling module might also be used to schedule the execution of tasks that are not related to individual patients. Such tasks might include administrative tasks, meetings, or special events.

The labels 78 include drop-down menus that allow the user to change when the next scheduled checkup will be. Such changes will be reflected in the progress bars 76. When the checkup occurs, the schedule is automatically updated to the next preconfigured checkup time. The preconfigured scheduling information comes from the server 14.

As shown in FIG. 2, at the bottom of the screen 22, to the left of the down arrow 66b, there is a “?” button 80. This button 80 takes a user to the client's 12 contextual help system. The “?” button 80 toggles between a normal mode, when buttons actually perform their intended function and a help mode, when buttons simply bring up a window that explains what the button does. Preferably, every screen used by the client 12 includes the “?” button 80.

Using the data entry area 24 of FIG. 2, or any other input means, such as a voice command or keyboard stroke, the user may enter a command to actuate an otherwise hidden pull-down menu (not shown). When made to appear, the pull-down menu may support functions supplemental as well as identical to functions supported directly by buttons on the display screen 22. Such functions may include logging in and out of the client for security purposes, changing display properties, altering alarm sounds, interfacing with peripheral settings, or changing program options and settings. It will be appreciated that the appearance, functionality, and means for invoking the pull-down menu may be modified in any number of ways.

Referring back to FIG. 7, on the top, left side of the screen is a button 82 labeled “Help.” This button 82 brings the user to an online help function for the client 12. The client 12 online help is different from the contextual help in that online help gives a general overview of the operation of the client 12 as well as the data collection system 10. The online help function is generally only available from the patient selection screen 58, as the user will typically be brought to the patient selection screen 58 when the client 12 is launched.

Applicaton Launch

The client 12 may be launched like any other software that runs on a personal data assistant or handheld computer. For example, FIG. 10 shows a view of the program launcher used to launch a client 12 configured to operate on a contemporary operating system. The circled graphical icon 84 represents the client 12 program. Simply tapping the icon 84 causes the client to be launched, i.e., the user will be brought to the patient selection screen 58 shown in FIG. 7.

One feature of the client 12 launch function is the ability to view data that has already been entered. The client may be placed in the view data mode by using a special text-entry command, or by toggling the View Data? button 86 on the statistic selection screen of FIG. 12A. View Data? 86 toggles the functionality of the statistic/module buttons 88 on that screen between the standard data-entry mode, which brings the user to the appropriate module, and a data-viewing mode that lists all of the entries on the screen for that statistic. An example of a view data screen 85 in the data-viewing mode is shown in FIG. 12B. One of ordinary skill will appreciate that since the scope of what a statistic can be is very broad, not every statistic lends itself to a listing of measurements.

Client User Interface

The client 12 is designed so the user-interface may be finger operated. In most cases, users may use a specialized stylus for tapping the display screen 22, which is “touch” sensitive. The stylus may be of the type used and sold and used in conjunction with personal data assistants sold under the trademarks Palm® or Pocket PC®.

The client 12 is also designed to permit a user to move quickly to a desired screen. FIG. 13 is a map of the overall user-interface flow for the client 12. FIG. 13 demonstrates how users may move from the initial program prompt to a patient-specific data-entry module via the statistic selection screens in an optimized number of taps. Thus, the user may navigate from a patient selection screen shown in FIG. 7, to a statistic selection screen shown in FIG. 12A, and then toggle button function alternatively between a view data screen 85 shown in FIG. 12B and data entry modules, such as those shown in FIGS. 3A, 3B, 3C, 3D, 4, 5, and 6. The streamlined user-interface is not only intuitive to use, it also saves time both in initial training and day-to-day data-entry.

Application Programming Interface

Flexible integration for software developers is an integral component of the present invention. Using the application programming interface, the data hierarchy may be altered at the module and meta-module level or expanded by creating additional modules and meta-modules. Furthermore, the API allows for supplemental plug-ins for the server, as well as the creation of hardware components that automate modules or meta-modules.

Section IV—Configuring the Client via the Server

Client-Server

Interface

The method of communication between client 12 and server 14 occurs using commonly known and used techniques such as but not limited to serial communication. The server 14 may link with the client 12 in many different ways, including Input and Output (I/O) interfaces, which may use internal or external expansion ports to interface via the IDE ATA, SCSI, SATA, RS-232, parallel, 1394, USB, or other similar connection, any of which may be used internally or externally to transfer information to and from the client 12. Additionally, the server 14 may be configured to communicate with the client 12 via a direct cable connection (DCC), Ethernet LAN, or other known network connection, potentially using landline, cellular, broadband, radio, or satellite WAN devices. As newer technologies develop, real-time wireless connection will become more standard and may be used to facilitate communication between the client 12 and the server 14. It will be appreciated that any number of wireless protocols may be used, not limited to those discussed under the SERVER heading of Section I.

Compatible with multiple operating system platforms, the server 14 may be used by skilled professionals or management-level users, all with the training and experience to direct appropriately the acquisition of specialized data, to configure the client's 12 memory with the appropriate data to be obtained, recorded, monitored or observed. For example, using the client-server user-interface, a physician may customize data sets to be collected or monitored for each patient and transfer the configured data file to a client 12 via the client-server user interface.

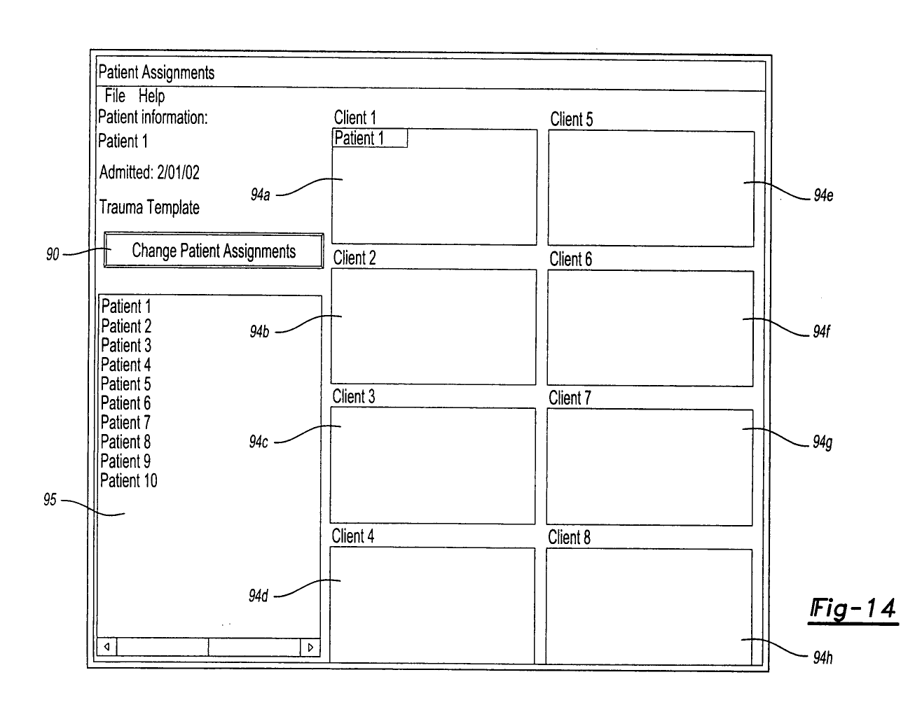

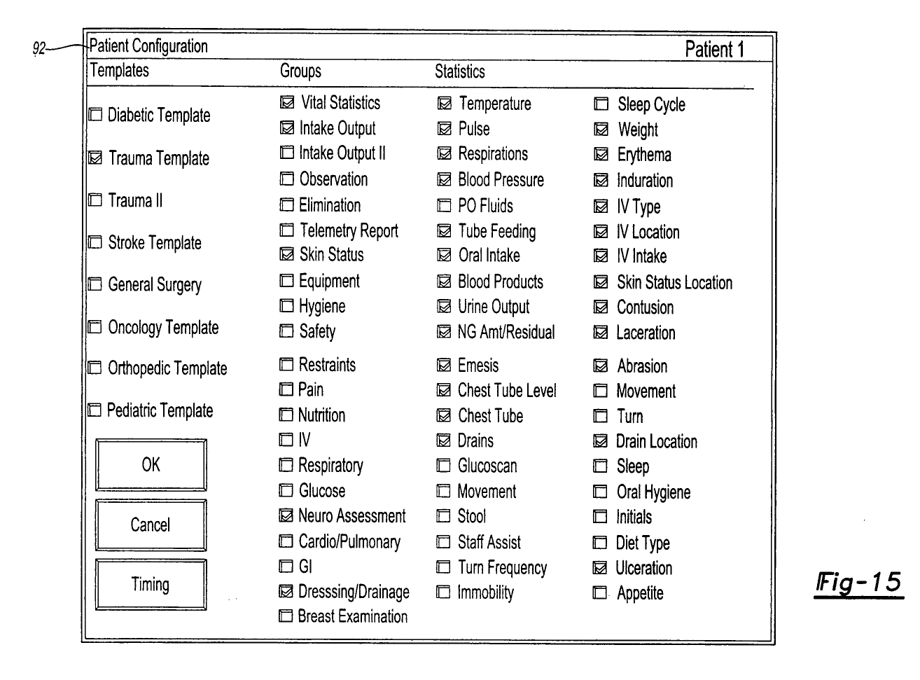

The patient assignments screen shown in FIG. 14 can be used to launch the interface that is used to assign each patient's profile, i.e., to generate the collection of templates, groups or statistics used to represent the data or information to be obtained, recorded, monitored or observed. Selecting any patient and either double-clicking or using the “Change Patient Assignments” button 90 will take the user to the patient configuration screen 92 shown in FIG. 15.

Referring to FIG. 15, the patient configuration screen displays columns. Each column, from left to right, reads Templates, Groups, and Statistics, respectively. Each column also contains a number of checkboxes. These checkboxes allow the user to toggle the activation status of each item. For example, this screen shows that the Trauma Template has been activated, as a check appears in the box adjacent the box labeled Trauma Template. By checking this one box, all of the groups and statistics that are implicated by the Trauma Template are automatically checked, and are, thus, included as part of the data set to be transferred to the client 12.

If the physician decides to check another template, the boxes checked from the original selection will remain and the newly selected groups and statistics will be added. Furthermore, the user may individually select or de-select groups and statistics. Since the data sets to be monitored are arranged as groups, any statistics activated that do not belong to a selected group will appear, in the client's statistic selection screen 46, under a group called “Custom”.

The person or device configuring the data sets to be collected can also assign each patient to a user or other health care worker. FIG. 14 demonstrates how users may assign patients by linking patients with individual instances of a client 12 that is assigned or will be assigned later to one or more users. Preferably, the client 12 will be assigned to users for the duration of their shift.

As shown in FIG. 14, the left side of the screen shows a listing of all the patients 95 in a particular area of the hospital or other environment. This data can either be entered by hand or collected automatically from the environment's electronic patient database 16. By clicking on a patient's name, the physician may drag that patient to any of the boxes to the right-labeled “Client” 94a-h. Each box 94a-h corresponds to a different instance of the client 12. Any number of additional patients may be added to more than one instance of the client 12.

The server 14 also permits the client 12 to be configured using the scheduling module 74. This module 74 is used to establish the scheduling parameters for each patient. For example, it is possible to schedule checkups or data gathering events for each patient.

Information Flow in the Data Collection System

In practice, there may be several instances of the client 12 running off of a single instance of the server 14. In addition, there may be several servers 14 running in various parts of the facility, each one talking to the same database 16 and a local set of clients 12. The configuration would look like that shown in FIG. 16A. Alternatively, the database 16 may be made a part of the client 12 to interface with the server 14. Furthermore, there may be several clients 12 running off of a server 14 and database 16 combination like that shown in FIG. 16B, such that the server 14 is incorporated into or co-installed with a pre-established database 16. It will be appreciated that various client 12, server 14, and database 16 permutations may be configured.

Information flows in two directions through the data collection system 10 as shown graphically in FIGS. 16A and 16B by arrows 96 through 97 and 98 through 99 respectively. In one direction, clinical data, acquired using the client 12, is sent back to the server where it is then logged permanently into the environment's existing electronic database 16. Information moving in this backward direction corresponds to the data acquisition capabilities of the data collection system 10, the capabilities of the client 12.

Moving in the other direction, the server 14 gathers basic information about selected patients and where these patients are located. Physicians or management-level users, using the client-server user-interface use the server 14 to configure the content and scheduling of data acquisition operations for one or more patients selected from a group of patients. In addition, each patient is paired with a line-user or other medical personnel who will be primarily responsible for caring for and acquiring data from this patient.

Because information moves in both directions through the data collection system 10, the server 14, being in the middle, serves as a kind of switching station to direct the flow of information in both directions as best seen in FIG. 16A. For example, the client 12 collects all of the desired information and sends it back to the server 14 in a single file. This process may be carried out via serial synchronization or scheduled wireless updates or other similar communication techniques. The server 14 then takes this file for each patient and sends it up to the database 16.

When the server 14 passes information to the client 12, each patient is assigned one or more unique identifiers, along with their name, age, and other static information. For example, each patient profiled in the client 12 has an assigned file where all of that patient's information is stored. Thus, the data acquired for each statistic for a particular patient is stored under a heading identified by a unique number assigned to the statistic under consideration. Preferably, all of a patient's information is grouped together, with the statistic numbers serving as headings for the acquired data for a particular statistic.

With regard to the upstream flow of information to the database 10, most large-scale databases generally include scripting languages for entering information into, and pulling information out of the database. Structured Query Language (SQL) and Oracle® are currently the most commonly used. Due to the use of scripting languages, the processes of sending information to, and extracting information from such databases employ standard and well known techniques. One of ordinary skill in the art will appreciate that the data collection system 10 uses such standard techniques to read and write information from and to the database 16.

Section V—Security

At the time of invention, regulatory bodies are considering a new patient privacy standard knows as HIPAA (Health Insurance Portability and Accountability Act). This initiative is, among other things, designed to improve the security and integrity of medically related documents and data. The data collection system 10 shall include security measures such as data encryption, password protection, biometric security authentication or other similar devices to help reduce unauthorized access to the data stored therein. These security measures may be used to regulate access to individual accounts so that both the client and server always know who is using them.

Preferred embodiments of the present invention have been disclosed. A person of ordinary skill in the art would realize, however, that certain modifications would come within the teachings of the invention. For example, It will be appreciated that a tutorial mode may be incorporated to train users in using the system without affecting real data. Therefore, the following claims should be studied to determine the true scope and content of the invention.

1. A data collection system comprising:
a display screen for displaying information, wherein the information is stored in one or more fields, said display screen being configured to permit selection of the one or more fields;
a storage device coupled to the display screen;
a microprocessor coupled to said storage device, said microprocessor programmed with instructions for manipulating the information;
a data acquisition device for permitting selection of at least one field from the one or more fields; and
a server coupled to said data acquisition device for transferring information to said data acquisition device and for configuring the data acquisition device to store and collect information, wherein the information is stored in the one or more fields.

2. The data collection system as defined in claim 1, wherein the information is stored in one or more data files comprising one or more fields that correspond to one or more data types to be recorded or monitored or both, the one or more data files being selected from a database comprising data files preconfigured according to particular requirements of the one or more data types to be measured, monitored or recorded, and the server further being adapted for transferring at least one of the one or more data files from the storage device to the database.

3. The data collection system as defined in claim 1, wherein the one or more data files are selected from a database comprising data files preconfigured according to a particular diagnosis or one or more symptoms, and the server further being adapted for transferring at least one of the one or more data files from the storage device to the database.

4. The data collection system defined in claim 2, wherein the data collection system permits the scheduling of the frequency of data acquisition.

5. The data collection system as defined in claim 1, wherein the data collection system includes a customizable statistic selection screen.

6. The data collection system as defined in claim 1 further including a scheduling module for scheduling patient assessments.

7. The data collection system defined in claim 1, wherein the data fields include one or more statistics to be recorded for one or more patients.

8. The data collection system defined in claim 7, wherein the statistic to be recorded is numerical information or text information.

9. The data collection system defined in claim 1, wherein said display screen is configured to permit selection of and alternation between one or more records for display.

10. The data collection system defined in claim 7, wherein the statistic to be recorded is locational information.

11. The data collection system defined in claim 7, wherein the statistic to be recorded is checklist type information.

12. The data collection system defined in claim 7, wherein the statistic to be recorded is descriptive information.

13. The data collection system defined in claim 7, wherein the one or more data files comprise one or more groups of information to be recorded for at least one of one or more patients.

14. The data collection system defined in claim 1, wherein the one or more data files comprise one or more groups of statistics to be recorded for at least one of one or more patients.

15. The data collection system as defined in claim 1, wherein the data collection system permits the display of all the groups in a selected patient's one or more data files.

16. The data collection system defined in claim 1, wherein the one or more data files comprise one or more templates for at least one of one or more patients.

17. The data collection system defined in claim 16, wherein the templates comprise one or more groups, one or more statistics or both.

18. The data collection system defined in claim 1, wherein the fields include one or more statistics to be recorded for at least one of one or more patients.

19. The data collection system defined in claim 1, wherein the one or more fields include one or more meta-statistics having properties to define how a statistic is used.

20. The data collection system defined in claim 1, wherein the data acquisition device comprises a selectively customizable interface adapted to permit recordation of various data types.

21. The data collection system defined in claim 20, wherein the data types comprise numerical, text, graphical, locational, audio, video, photographic, question-answer, descriptive or checklist information.

22. The data collection system as defined in claim 20, wherein the data collection system permits information to be transmitted via wired or wireless connection.

23. The data collection system defined in claim 1, wherein the one or more data files include a graphical representation of a human body, wherein a user input device is used to mark selected locations on the graphical representation that correspond to physical locations on at least one of one or more patients.

24. The data collection system defined in claim 1, wherein the data acquisition device is portable.

25. A data collection system for storing information for one or more patients, comprising:
a display screen for displaying information;
a storage device coupled to the display screen;
a data acquisition device for permitting the selection of at least one patient from the one or more patient data files of said storage device and for recording information into selected fields of the one or more data files for the selected patient;
a microprocessor connected to the storage device, said microprocessor programmed with instructions for manipulating the information; and
a server connected to the storage device for transferring one or more selected data files for each of the one more patients to the storage device, wherein the selected data files are selected from a database comprising data files preconfigured according to a diagnosis or one or more symptoms for the respective patients of the one or more patients, the server further being adapted for transferring at least one of the one or more selected data files from the storage device to the database, wherein at least a portion of one of the selected data files transferred from the storage device has been modified to include information recorded by the data acquisition device or entered by the user.

26. The data collection system as defined in claim 25, wherein the data collection system includes a customizable statistic selection screen.

27. The data collection system as defined in claim 25, further including a scheduling module for scheduling information manipulation.

28. The data collection system defined in claim 25, wherein the data fields include one or more statistics to be recorded for at least one of the one or more patients.

29. The data collection system defined in claim 25, wherein the one or more data fields include one or more meta-statistics having properties to define how a statistic is used.

30. The data collection system defined in claim 25, wherein the data acquisition device is portable.

31. The data collection system defined in claim 28, wherein the statistic to be recorded is numerical information.

32. The data collection system defined in claim 28, wherein the statistic to be recorded is text information.

33. The data collection system defined in claim 28, wherein the statistic to be recorded is locational information.

34. The data collection system defined in claim 28, wherein the statistic to be recorded is checklist type information.

35. The data collection system defined in claim 28, wherein the statistic to be recorded is descriptive information.

36. The data collection system defined in claim 25, wherein the one or more data files comprise one or more groups of information to be recorded for at least one of the one or more patients.

37. The data collection system as defined in claim 25, wherein the data collection system includes one or more group tabs that permit the display of one or more groups in a selected patient's data file.

38. The data collection system defined in claim 25, wherein the one or more data files comprise one or more templates for at least one of the one or more patients.

39. The data collection system defined in claim 38, wherein the templates comprise one or more groups, one or more statistics or both.

40. The data collection system defined in claim 25, wherein the data acquisition device comprises a selectively customizable interface adapted to permit recordation of various data types.

41. The data collection system defined in claim 40, wherein the data types comprise numerical, text, graphical, locational, audio, video, photographic, question-answer, descriptive or checklist information.

42. The data collection system as defined in claim 40, wherein the data acquisition device permits information to be collected via wired or wireless communication.

43. The data collection system defined in claim 25, wherein the one or more data files include a graphical representation of a human body, wherein a user input device is used to mark selected locations on the graphical representation that correspond to physical locations on at least one of the one or more patients.

44. The data collection system defined in claim 25, wherein said display screen is configured to permit selection of and alternation between one or more records for display.

45. A method for collecting information for one or more patients, the method comprising:
providing a data collection system having a storage device;
configuring the storage device for storing information concerning the one or more patients, the information being stored in one or more data files comprising one or more fields that correspond to one or more data types to be recorded or monitored or both based on a diagnosis or one or more symptoms for each patient of the one or more patients; and
collecting information using a data acquisition device, wherein the data acquisition device permits the selection of at least one patient from the one or more patient data files of said storage device and to record information into selected fields of the one or more fields of said storage device for the selected patient.

46. The method defined in claim 45, further including the step of providing a server connected to the storage device for transferring the one or more data files for the one more patients to the storage device, wherein the one or more data files are selected from a database comprising data files preconfigured according to a particular diagnosis or one or more symptoms and identifying the data types to be measured, monitored or recorded, the server further being adapted for transferring at least one of the one or more data files from the storage device to the database, wherein at least one of the one or more data files transferred from the storage device has been modified to include information recorded using the data acquisition device.

47. The method defined in claim 43, further including the step of identifying statistics to be measured, monitored or recorded for each patient comprising the one or more patients.

48. The method defined in claim 43, further including the step of identifying meta-statistics to be measured, monitored or recorded for each patient comprising the one or more patients.

49. The method defined in claim 43, further including the step of storing the one or more data files associated with the respective patients of the one or more patients into one or more groups, wherein the data type comprising each group is selected based on one or more symptoms or a diagnosis for the respective patient.

50. The method defined in claim 45, further including the step of storing the one or more data files associated with the respective patients of the one or more patients into templates, each template comprising one or groups preconfigured based on one or more symptoms or a diagnosis for the respective patient.

51. The method defined in claim 46, further including the step of downloading preconfigured groups or templates from the database for each patient of the one or more patients and transferring said preconfigured groups or templates to the storage device.

52. The data collection system as defined in claim 1, further including a data hierarchy and an application programming interface.

53. The data collection system as defined in claim 52, the application programming interface being configured to permit alteration of the data hierarchy.

54. The data collection system as defined in claim 53, the data hierarchy including at least one module and at least one meta-module.

55. The data collection system as defined in claim 52, the application programming interface being adapted to expand the data hierarchy by creating an additional item selected from the group consisting of modules and meta-modules.

56. The data collection system as defined in claim 52, the application programming interface being configured to permit at least one supplemental plug-in for the server.

57. The data collection system as defined in claim 54, the application programming interface being further configured to create of at least one hardware component to automate an item selected from group consisting of the at least module and the at least one meta-module.
